(19) United States
(12) Patent Application Publication
(10) Pub. No.: US 2011/0144912 A1
(43) Pub. Date: Jun. 16, 2011

(54) SYSTEM FOR SAFETY OF VESSEL AND METHOD FOR SAFETY OF VESSEL

(75) Inventors: Sung Jong Lee, Busan (KR); Seung Keon Lee, Busan (KR); Si Hong Kim, Daegu (KR)

(73) Assignee: Young Sick Kim, Busan (KR)

(21) Appl. No.: 12/962,973

(22) Filed: Dec. 8, 2010

(30) Foreign Application Priority Data
Dec. 10, 2009 (KR) 10-2009-0122732

(51) Int. Cl. G08G 3/02; G08G 3/00

(52) U.S. Cl. 701/301; 701/300; 340/985

(57) ABSTRACT

The present invention relates to a system for safety of a vessel and a method for safety of the vessel, and more particularly, to a system for safety of a vessel and a method for safety of the vessel using a mobile terminal device. According to the exemplary embodiment of the present invention, it is possible to provide a vessel collision preventing function which is available only in high-price exclusive marine equipment by utilizing a radio communication function and a location tracking function of a mobile terminal device even to small and medium-sized vessels and furthermore, rapidly and accurately display a vessel which is in a collision risk and allow a user to specifically recognize a collision preventing alarm so as to prevent collisions of the vessels.

### CROSS-REFERENCE TO RELATED APPLICATIONS

This application claims priority under 35 U.S.C. §119 to Korean Patent Application No. 10-2009-0122732, filed on Dec. 10, 2009 in the Korean Intellectual Property Office, the disclosure of which is incorporated herein by reference in its entirety.

### TECHNICAL FIELD

The present invention relates to a system for safety of a vessel and a method for safety of the vessel, and more particularly, to a system for safety of a vessel and a method for safety of the vessel using a mobile terminal device.

### BACKGROUND

Most of vessel accidents include collision accidents such as a collision between vessels, a collision between the vessel and a fixed obstacle, and the like. In recent years, as the size of the vessel has increasingly become larger and the type of the vessel has diversified, large-scale damages such as personal injuries, property damages, and secondary damages such as marina pollution has occurred. Since the vessel collision accidents generally occurred around harbors and in coastal seas where the vessels frequently come and go, automatic identification system (AIS) data, port traffic management system (PTMS) data, or electronic chart display and information system (ECDIS) data associated with vessels and fixed obstacles in the seas were provided to VTS controllers, port pilots, or vessel operators. Further, according to the agreement of the International Marine Organization (IMO), 300 ton or more of foreign sailing vessels and 500 ton or more of domestic sailing vessels were obligatorily equipped with AIS equipment since 2002 and the effectiveness of being equipped with AIS equipment were demonstrated through associated reports.

In contrast, most (70%) of the vessel collision accidents were incurred by 100 ton or less small and medium size vessels in seas close to land (Korean Maritime Safety Tribunal, 2003 to 2008) and result in personal (31%), property, and environmental accidents.

However, most of the small-sized vessels such as a fishing boat or a small-sized boat were not able to install the AIS equipment due to installation cost, equipment operation, limited space for equipment installation in the small-sized vessel in order to hold a marine radar or radio communication equipment for receiving the data. Further, since communication equipment does not need to be obligatorily installed legally, the small-sized vessels are not equipped with the marine radar or the radio communication equipment for preventing vessel collisions.

Meanwhile, a fire or an explosion of an engine room of the small-sized vessel may result in serious marine casualties including the personal injury. Further, a currently used sinking vessel distress signal generator operates when water pressure is generated by sinking of a vessel. This transmits a distress signal after the vessel has completely sunk and when a rescue request signal needs to be transmitted very quickly, however, flooding of the engine morn of the vessel is still considered a serious failure situation in which an immediate rescue should be made even if the vessel has not completely sunk.

### SUMMARY

The present invention has been made in an effort to provide a system for safety of a vessel and a method for safety of the vessel that can prevent collisions of vessels by providing a vessel collision preventing function which is available only in high-price exclusive marine equipment by utilizing a radio communication function and a location tracking function of a mobile terminal device even to small and medium-sized vessels.

Further, the present invention has been made in an effort to provide a system for safety of a vessel and a method for safety of the vessel that can take action against vessel accidents in early stages by immediately transmitting an accident occurrence signal through a radio communication function of a mobile terminal device when accidents such as a fire, collision, flooding, and the like occur in the vessel.

Objects to be solved by the present invention are not limited to the above-mentioned objects and other objects to be solved by the present invention which are not mentioned will be apparently appreciated by those skilled in the art from the following description.

An exemplary embodiment of the present invention provides a system for safety of a vessel, the system including: a marine information providing device generating and providing marine information on a plurality of vessels and fixed obstacles positioned at sea; a central server device receiving and integrating the marine information and generating own-vessel's surrounding situational information depending on a location of a user's vessel; and a mobile terminal-device accessing the central server device to transmit the positional information of the user's vessel, receiving and displaying the own-vessel's surrounding situational information, generating vessel collision preventing information from the own-vessel's surrounding situational information to give an alarm, and displaying the own-vessel's surrounding situational information by compulsorily updating or reprocessing the own-vessel's surrounding situational information according to the input of a setup key.

The mobile terminal device may include: an information transmitting and receiving unit accessing the central server device to transmit the positional information of the user's vessel and receive the own-vessel's surrounding situational information; a vessel collision preventing information generating unit generating the vessel collision preventing information on the basis of the own-vessel's surrounding situational information; a setup changing unit compulsorily updating or reprocessing the own-vessel's surrounding situational information according to the input of the setup key; and an information displaying unit displaying the own-vessel's surrounding situational information and alarming the vessel collision preventing information.

The mobile terminal device may display the own-vessel's surrounding situational information by displaying the user's vessel as a triangle of which the position is fixed on the screen, displaying the distance from the user's vessel as concentric circles which are displayed at regular intervals on the basis of the user's vessel, display other vessels as circles according to their positions, display the vessels as colors according to their sizes, display the vessels as direction lines drawn from circles according to their operating directions, and display the vessels as the number of the direction lines according to the operating speeds, and display the fixed obstacles as quadrangles.

The mobile terminal device may generate and alarm the vessel collision preventing information by calculating a DCPA and a TCPA of each of a plurality of vessels or fixed obstacles with the user's vessel on the basis of the own-vessel's surrounding situational information, when the DCPA and the TCPA are equal to or less than the collision preventing threshold value, displaying the DCPA and the TCPA, the speeds of the vessel and the user's vessel, and a vessel collision preventing alarm statement and generating vessel collision preventing alarm sound or alarm vibration, and displaying a collision preventing operating direction depending on the positions of the vessels or fixed obstacles.

The mobile terminal device may receive telephone number information of a mobile terminal device positioned in another vessel of which the DCPA and the TCPA are equal to or less than the collision preventing threshold value by accessing the central server device and display a call connection to the telephone number.

The information inputted by the setup key may include at least one of a compulsory updating command, a distance interval of concentric circles displayed on a screen, selection of an alarm type, an access cycle of a central server, change of the collision preventing threshold value, registration of the specification of the user's vessel, and the like.

The central server device or the mobile terminal device may include an information storing unit storing the own-vessel's surrounding situational information or the vessel collision preventing information.

The system may further include a vessel state detecting device including a vessel damage detecting unit detecting whether a user's vessel is damaged, a vessel inclination detecting unit detecting capsizing of the user's vessel, a vessel flooding detecting unit detecting whether the user's vessel is flooded, a vessel fire detecting unit detecting whether the user's vessel is on fire, a vessel collision detecting unit detecting whether the user's vessel is collided, and a short-distance wireless communication unit converting detection values of the detecting units into vessel state signals and transmitting them to a mobile terminal device in the user's vessel, wherein when each of the detection values of the vessel state signals received from the short-distance wireless communication unit is equal to or more than a predetermined accident judging reference value, the mobile terminal device alarms vessel accident information and immediately transmit a vessel accident signal to the central server device.

Another exemplary embodiment of the present invention provides a method for safety of a vessel, the method including: transmitting of positional information of accessing a mobile terminal to a central server to transmit the positional information of the user's vessel; displaying of own-vessel's surrounding situational information of receiving the own-vessel's surrounding situational information of the user's vessel from the central server and displaying the received information on a screen of the mobile terminal; judging of a vessel collision risk of generating a DCPA and a TCPA from the own-vessel's surrounding situational information to judge the vessel collision risk or not; alarming of vessel collision prevention of generating vessel collision preventing information based on the own-vessel's surrounding situational information to display the DCPA, the TCPA, speeds of the vessel and the user's vessel, and a vessel collision preventing alarm statement on the screen of the mobile terminal, generating vessel collision preventing alarm sound or alarm vibration in the Mobile terminal, and displaying a collision preventing operating direction on the screen of the mobile terminal; displaying of a call connection or not of receiving telephone number information of a mobile terminal positioned in a vessel which is under a collision risk by accessing the central server and displaying a call connection to the telephone number or not in the mobile terminal of the user's vessel; and displaying of setup change information of displaying the own-vessel's surrounding situational information on the screen of the mobile terminal by compulsorily updating and reprocessing the corresponding information according to the input of the setup key of the mobile terminal.

Other features and aspects will be apparent from the following detailed description, the drawings, and the claims.

### BRIEF DESCRIPTION OF THE DRAWINGS

FIG. 1 is a diagram for describing a system for safety of a vessel according to an exemplary embodiment of the present invention;

FIG. 2 is a diagram for describing a mobile terminal device according to an exemplary embodiment of the present invention;

FIG. 3 is a diagram illustrating a screen of a mobile terminal device displaying surrounding situational information according to an exemplary embodiment of the present invention;

FIG. 4 is a diagram illustrating a screen of a mobile terminal device displaying vessel collision preventing information according to an exemplary embodiment of the present invention;

FIG. 5 is a diagram illustrating a screen of a mobile terminal device displaying a call connection according to an exemplary embodiment of the present invention;

FIG. 6 is a diagram illustrating a screen of a mobile terminal device displaying setup change information according to an exemplary embodiment of the present invention:

FIG. 7 is a diagram for describing a method for safety of a vessel according to an exemplary embodiment of the present invention; and

FIG. 8 is a diagram for describing a system for safety of a vessel according to another exemplary embodiment of the present invention.

### DETAILED DESCRIPTION OF EMBODIMENTS

Hereinafter, exemplary embodiments will be described in detail with reference to the accompanying drawings. Throughout the drawings and the detailed description, unless otherwise described, the same drawing reference numerals will be understood to refer to the same elements, features, and structures. The relative size and depiction of these elements may be exaggerated for clarity, illustration, and convenience. The following detailed description is provided to assist the reader in gaining a comprehensive understanding of the methods, apparatuses, and/or systems described herein. Accordingly, various changes, modifications, and equivalents of the methods, apparatuses, and/or systems described herein will be suggested to those of ordinary skill in the art. Also, descriptions of well-known functions and constructions may be omitted for increased clarity and conciseness.

Hereinafter, the present invention will be described in detail with reference to the accompanying drawings.

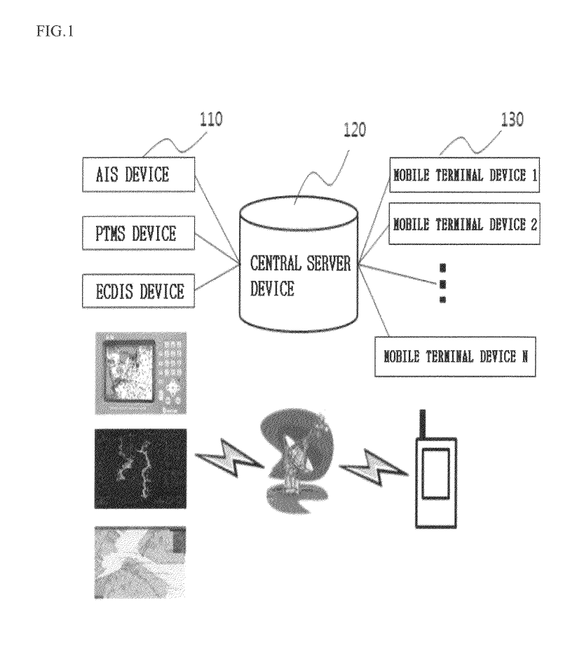

FIG. 1 is a diagram for describing a system for safety of a vessel according to an exemplary embodiment of the present invention.

As shown in FIG. 1, the vessel safety system according to the exemplary embodiment of the present invention includes a marine information providing device 110, a central server device 120, and a mobile terminal device 130.

The marine information providing device 110 generates and provides marine information on a plurality of vessels and fixed obstacles positioned in the sea. The marine information providing device 110, which includes at least one of an automatic identification system (AIS) device, a port traffic management system PTMS) device, or an electronic chart display and information system (ECDIS) device, is generally used around harbors and in coastal seas where the vessels frequently come and go.

The vessel safety system according to the exemplary embodiment of the present invention receives and uses the marine information from the marine information providing device to allow the central server device 120 and the mobile terminal device 130 to accurately and reliably generate and use own-vessel's surrounding situational information and vessel collision preventing information.

The central server device 120 receives and integrates the marine information and generates own-vessel's surrounding situational information depending on a location of a user's vessel. In detail, the central server device 120 is operated in link with at least one marine information providing device 110 such as the AIS device, the PINS device, or the ECDIS device. The central server device 120 sets an own-vessel on the basis of the positional information of the user's vessel received from the mobile terminal device 130 and generates own-vessel's surrounding situational information on vessels and fixed obstacles around the own-vessel. Further, the central server device 120 provides the own-vessel's surrounding situational information to the mobile terminal device 130 periodically every minute and provides the own-vessel's surrounding situational information in real time when the user's vessel is under a collision risk.

The mobile terminal device 130 accesses the central server device 120 to transmit the positional information of the user's vessel, receives and displays the own-vessel's surrounding situational information, generates vessel collision preventing information from the own-vessel's surrounding situational information to give an alarm, and compulsorily updates or reprocesses the own-vessel's surrounding situational information according to the input of a setup key.

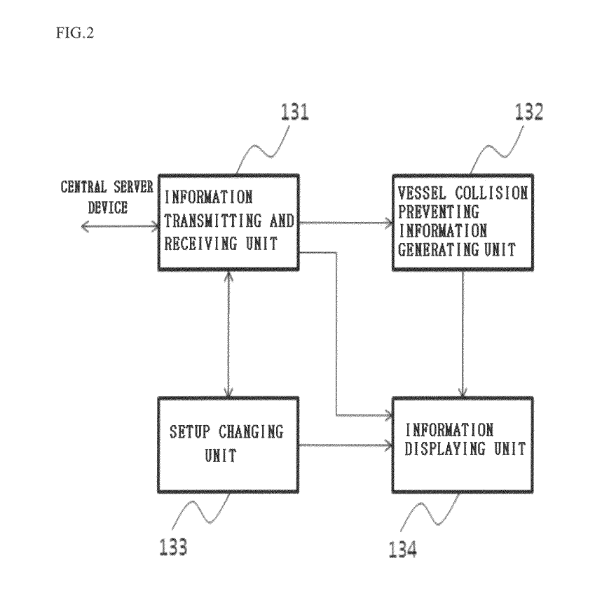

In detail, a vessel operator executes a program of the mobile terminal device 130 downloaded prior to operate the vessel. The mobile terminal device 130 automatically accesses the central server device 120 to update the own-vessel's surrounding situational information. Components, features, operational principle, and the like of the mobile terminal device 130 for displaying the own-vessel's surrounding situational information, alarming the vessel collision preventing information, and changing the setup will be described below in more detail with reference to FIGS. 2 to 6.

The vessel safety system according to the exemplary embodiment of the present invention may provide a vessel collision preventing function which is available only in high-price exclusive marine equipment by utilizing a radio communication function and a location tracking function of a mobile terminal device even to small and medium-sized vessels and furthermore, rapidly and accurately display a vessel which is in a collision risk and allow a user to specifically recognize a collision preventing alarm so as to prevent collisions of the vessels.

FIG. 2 is a diagram for describing a mobile terminal device according to an exemplary embodiment of the present invention.

As shown in FIG. 2, the mobile terminal device according to the exemplary embodiment of the present invention includes an information transmitting and receiving unit 131, a vessel collision preventing information generating unit 132, a setup changing unit 133, and an information displaying unit 134.

The information transmitting and receiving unit 131 accesses the central server device 120 to transmit the positional information of the user's vessel and receive the own-vessel's surrounding situational information. The information transmitting and receiving unit 131 transmits and receives the positional information of the user's vessel and the own-vessel's surrounding situational information periodically every minute and transmits and receives the positional information of the user's vessel and the own-vessel's surrounding situational information in real time when the user's vessel is under a collision risk. Herein, the positional information of the user's vessel is information on a positional value of the user's vessel or a user's vessel moving direction and may adopt reception information of GPS or a mobile communication base station.

The vessel collision preventing information generating unit 132 generates the vessel collision preventing information on the basis of the own-vessel's surrounding situational information. The vessel collision preventing information generating unit 132 uses a distance closest point of approach (DCPA) and a time closest point of approach (TCPA) between the vessel or fixed obstacle and the user's vessel in order to generate the vessel collision preventing information. Herein, when two vessels pass closest to each other while maintaining their directions and speeds as it is, the DCPA represents the closest distance therebetween and the TCPA represents an expected time from the present time to the time when two vessels pass a point closest to each other. When these values are equal to or less than a predetermined collision preventing threshold value, the vessel collision preventing information generating unit 132 generates the vessel collision preventing information for alarming.

The setup changing unit 133 compulsorily updates or reprocesses the own-vessel's surrounding situational information according to the input of the setup key. Information which can be set by the user includes a compulsory updating command, an interval of concentric circles displayed on a screen, selection of an alarm type, an access cycle of a central server, change of the collision preventing threshold value, registration of the specification of the user's vessel, and the like.

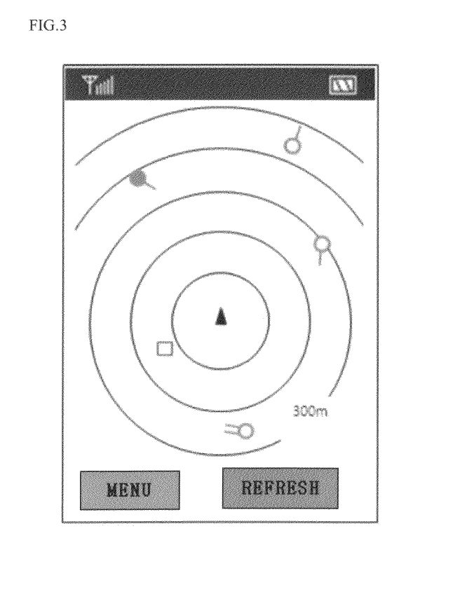

The information displaying unit 134 displays the own-vessel's surrounding situational information and alarms the vessel collision preventing information. A screen displayed in the mobile terminal device 130 by the information displaying unit 134 is shown in FIGS. 3 to 6.

As such, the mobile terminal device according to the exemplary embodiment of the present invention may provide a vessel collision preventing function which is available only in high-price exclusive marine equipment by utilizing a radio communication function and a location tracking function of the mobile terminal device even to small and medium-sized vessels.

FIG. 3 is a diagram illustrating a screen of a mobile terminal device displaying own-vessel's surrounding situational information according to an exemplary embodiment of the present invention.

As shown in FIG. 3, the mobile terminal device displays the user's vessel, a distance from the user's vessel, positions, sizes, operating directions, and operating speeds of other vessels, fixed obstacles on its screen to show the own-vessel's surrounding situational information.

In detail, the user's vessel is displayed as a triangle of which the position is fixed on the screen. The distance from the user's vessel is displayed as concentric circles which are displayed at regular intervals on the basis of the user's vessel. That is, the distance from the user's vessel is displayed as distance concentric circles at intervals of 100 m, 200 m, and 300 m on the basis of the user's vessel which is positioned at the center of the screen. Some of the concentric circles are additionally displayed in front of the user's vessel.

Other vessels are displayed as circles according to their positions. Further, other vessels are displayed as colors according their sizes. For example, a large-sized vessel as a 300-ton or more vessel according to the information received from the marine information providing device is displayed by tilling the inner part of a circle with a red color and a vessel less than 300 ton is displayed by filling the inner part of the circle with a white color. Further, other vessels are displayed as direction lines drawn from the circles indicating other vessels according to their operating directions. Drawing directions of the direction lines becomes the operating directions of the other vessels.

Further, other vessels are displayed as the number of the direction lines according to the operating speeds. For example, as shown in FIG. 3, one direction line indicates a low-speed vessel and two direction lines indicate a high-speed vessel. No direction line indicates a stop state of a vessel. Further, the fixed obstacles are displayed as quadrangles and the fixed obstacles correspond to marine floating matters or reefs. Coastal features not shown are displayed as shapes of costal features received on the basis of electronic navigation chart information among the marine information.

As such, the own-vessel's surrounding situational information according to the exemplary embodiment of the present invention is displayed in the mobile terminal device as shown in FIG. 3 to allow the user to well recognize the own-vessel's surrounding situation. Meanwhile, figures, colors, direction lines, and the like displayed according to the exemplary embodiment of the present invention as one displaying method for displaying the own-vessel's surrounding situation so as for the user to easily recognize the corresponding situation may be displayed by changing the shapes of the figures, the colors of the figures, the direction lines, and the like as necessary.

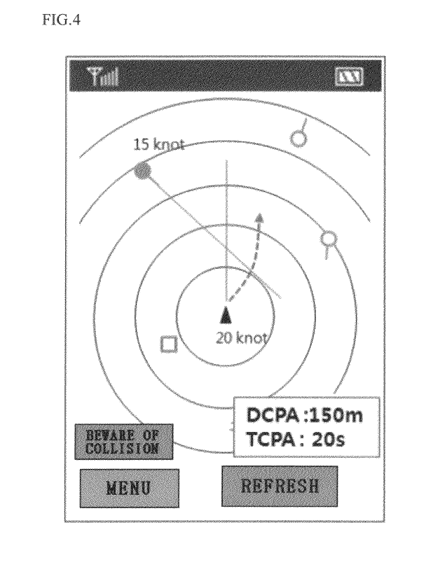

FIG. 4 is a diagram illustrating a screen of a mobile terminal device displaying vessel collision preventing information according to an exemplary embodiment of the present invention.

As shown in FIG. 4, the mobile terminal device generates and alarms the vessel collision preventing information by using the own-vessel's surrounding situational information.

First, a DCPA and a TCPA of each of a plurality of vessels or fixed obstacles with the user's vessel are calculated on the basis of the own-vessel's surrounding situational information.

Next, it is judged whether each of the DCPA and the TCPA is equal to or less than a predetermined collision preventing threshold value.

Next, when the DCPA and the TCPA are equal to or less than the collision preventing threshold value, the DCPA and the TCPA are displayed on a lower right end of the mobile terminal device and a vessel collision preventing alarm statement with a phrase “Beware of collision” is displayed on a lower left end of the screen of the mobile terminal device. Further, the speeds of the vessel and the user's vessel are displayed around the figures.

In addition, vessel collision preventing alarm sound or alarm vibration is generated in the mobile terminal device.

Moreover, a collision preventing operating direction depending on the positions of the vessels or fixed obstacles is displayed. For example, as shown in FIG. 4, when another vessel accesses with the DCPA and the TCPA which are equal to or less than the collision preventing threshold value, an expected progress path of the vessel is displaced by a solid line. Further, an expected path when the user's vessel progresses in the current state is displayed by a blue solid line and a recommended path capable of reducing the collision preventing operating direction, that is, a collision risk is displayed by a blue dotted line. The collision preventing operating direction is determined by using a general vessel collision avoiding algorithm. In this case, since an operator of another vessel cannot be recognized, a direction capable of maximally reducing the collision risk is recommended assuming that the current speed and direction are maintained. That is, the operating path in a direction to reduce the DCPA is displayed by a blue dotted line.

As such, a vessel which is under the collision risk may be rapidly and accurately displayed by displaying the vessel collision preventing information according to the exemplary embodiment of the present invention in the mobile terminal device as shown in FIG. 4 so as to allow the user to easily recognize the collision preventing alarm.

Meanwhile, in the exemplary embodiment of the present invention, the information on the collision preventing operating direction is displayed on the screen of the mobile terminal device, but in another exemplary embodiment, judgment information on whether to continuously maintain the current operation speed of the user's vessel, information whether to increase the DCPA and the TCPA to be more than the collision preventing threshold value may be additionally generated and displayed by accelerating or decelerating the user's vessel. Further, stranding risk beware/alarm notice information using the positions of the vessels and the fixed features and depth information of the electronic navigation chart may be generated and displayed.

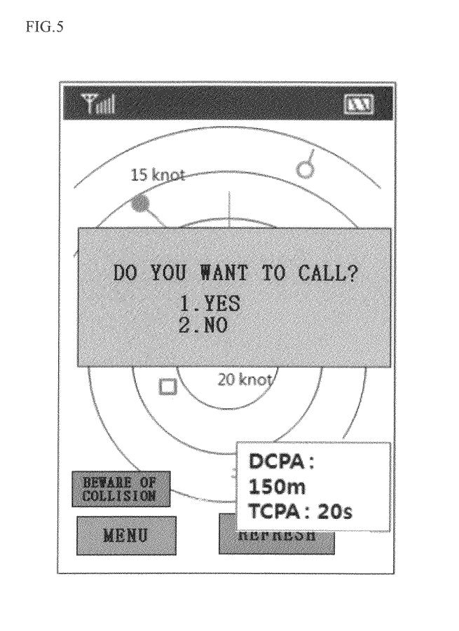

FIG. 5 is a diagram illustrating a screen of a mobile terminal device displaying a call connection according to an exemplary embodiment of the present invention.

As shown in FIG. 5, the mobile terminal device receives telephone number information of a mobile terminal device positioned in another vessel of which the DCPA and the TCPA are equal to or less than the collision preventing threshold value by accessing the central server device and displays a call connection to the telephone number in addition to performing the alarm shown in FIG. 4. As a result, the vessel operators may mutually perform rapid and accurate collision avoiding, operations through mutual rapid call connections among them so as to more effectively prevent the collision risk of the vessels.

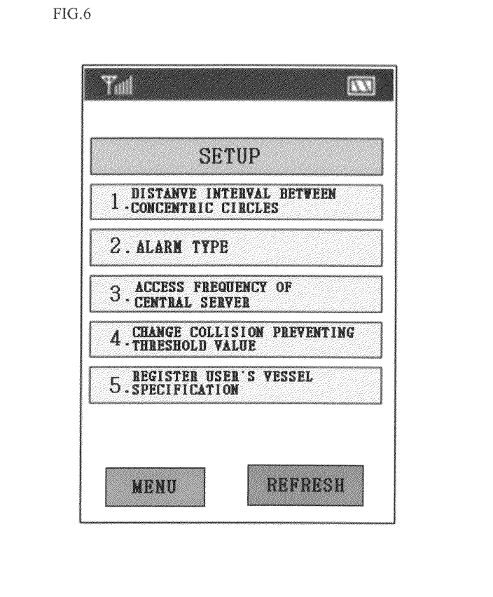

FIG. 6 is a diagram illustrating a screen of a mobile terminal device displaying setup change information according to an exemplary embodiment of the present invention.

As shown in FIG. 6, the mobile terminal device may display the own-vessel's surrounding situational information by compulsorily updating or reprocessing the corresponding information according to the input of the setup key. The information inputted by the setup key includes at least one of a compulsory updating command, a distance interval of concentric circles displayed on a screen, selection of an alarm type, an access cycle of a central server, change of the collision preventing threshold value, registration of the specification of the user's vessel, and the like.

For example, the own-vessel's surrounding situational information is compulsorily updated from the central server device by inputting a “refresh” key. Further, the distance interval of the concentric circles displayed on the screen, the selection of the alarm type, the access cycle of the central server, the change of the collision preventing threshold value, or the registration of the specification of the user's vessel are changed and set by inputting a “menu” key. In detail, the distance interval of the concentric circles displayed on the screen may be set wider or narrower in units of 100 m in 100 m, 200 m, and 300 m. The alarm type may be set as any one of alarm sound and alarm vibration. The automatic access cycle of the central server may be set longer or shorter every minute. The collision preventing threshold value may be set higher or lower as necessary.

Further, the mobile terminal device inputs the specification of the user's vessel, that is, information on the size, weight, and the like of the vessel and transmits the corresponding information to the central server device and the central server device transmits the specification information of the user's vessel to the marine information providing device to sufficiently perform a vessel's specification information exchanging function of the AIS device used in the large-sized vessel without the AIS device.

As such, in the exemplary embodiment of the present invention, a predetermined parameter is arbitrarily set according to the condition of the user's vessel or as necessary to display the own-vessel's surrounding situational information by compulsorily updating or reprocessing the corresponding information, as a result, it is possible to generate accurate and reliable information according to the situation.

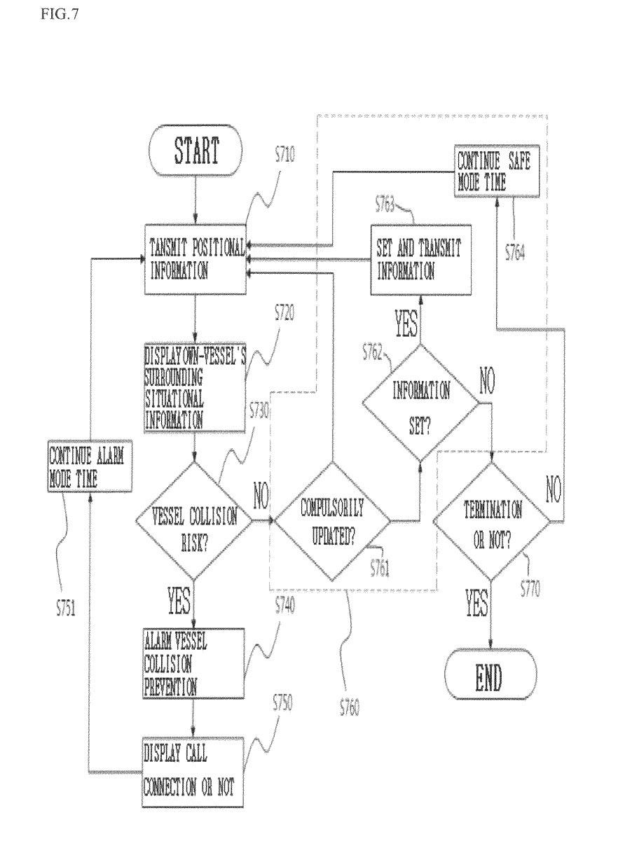

FIG. 7 is a diagram for describing a method for safety of a vessel according to an exemplary embodiment of the present invention.

As shown in FIG. 7, the vessel safety method according to the exemplary embodiment of the present invention includes transmitting positional information (S710), displaying own-vessel's surrounding situational information (S720), judging a vessel collision risk (S730), alarming vessel collision prevention (S740), displaying a call connection or not (S750), and displaying setup change information (S760).

First, at the transmitting of the positional information (S710), a mobile terminal accesses to a central server to transmit the positional information of the user's vessel.

Next, at the displaying of the own-vessel's surrounding situational information (S720), the own-vessel's surrounding situational information of the user's vessel is received from the central server to be displayed on a screen of the mobile terminal.

Then, at the judging of the vessel collision risk (S730), a DCPA and a TCPA are generated from the own-vessel's surrounding situational information to judge the vessel collision risk or not. For example, a DCPA and a TCPA between a vessel or a fixed obstacle and the user's vessel are calculated and it is judged whether each of the DCPA and the TCPA is equal to or less than a predetermined collision preventing threshold value. When the DCPA or the TCPA is equal to or less than the threshold value, the subsequent alarming of the vessel collision prevention (S740) is performed and when the DCPA or the TCPA is more than the threshold value, the subsequent displaying of the setup change information (S760) is performed.

Next, at the alarming of the vessel collision prevention (S740), vessel collision preventing information is generated based on the own-vessel's surrounding situational information to display the DCPA, the TCPA, speeds of the vessel and the user's vessel, and a vessel collision preventing alarm statement on the screen of the mobile terminal, generate vessel collision preventing alarm sound or alarm vibration in the mobile terminal, and display a collision preventing operating direction on the screen of the mobile terminal.

Next, at the displaying of the call connection or not (S750), telephone number information of a mobile terminal positioned in a vessel which is under a collision risk is received by accessing the central server and a call connection to the telephone number or not is displayed in the mobile terminal of the user's vessel. In this case, the process proceeds to continuing an alarm mode time (S751) at which a vessel collision preventing alarm is continued regardless of the call connection or not to continuously perform an alarm at the alarming of the vessel collision prevention (S740). The collision preventing alarm continuously forms a closed loop under the vessel collision risk.

Next, at the displaying of the setup change information (S760), the own-vessel's surrounding situational information is displayed on the screen of the mobile terminal by being compulsorily updated or reprocessed according to the input of the setup key of the mobile terminal.

In detail, the displaying of the setup change information (S760) forms a closed loop by including judging whether to compulsorily update the own-vessel's surrounding situational information (S761), judging whether to set various information such as a distance interval of concentric circles displayed on a screen, selection of an alarm type, an access cycle of a central server, change of the collision preventing threshold value, registration of the specification of the user's vessel, and the like (S762), setting information through a setup key and transmitting the set information to the central server (S763), and continuously displaying own-vessel's surrounding information by periodically and automatically updating the own-vessel's surrounding information because the setup key is not inputted (S764).

Next, the display of the mobile terminal is terminated according to judging termination or not (S770).

Since the detailed contents for executing the vessel safety method of the present invention is the same or similar as the system according to the exemplary embodiment of the present invention, the same or similar contents are substituted by the contents described through FIGS. 1 to 6.

As such, the vessel safety method according to the exemplary embodiment of the present invention can provide a vessel collision preventing function which is available only in high-price exclusive marine equipment by utilizing a radio communication function and a location tracking function of a mobile terminal device even to small and medium-sized vessels and furthermore, rapidly and accurately display a vessel which is in a collision risk and allow a user to specifically recognize a collision preventing alarm so as to prevent collisions of the vessels.

### Another Exemplary Embodiment

(a) In another exemplary embodiments, an information storing unit is provided in a central server device or a mobile terminal device to store own-vessel's surrounding situational information or vessel collision preventing information. As a result, after a program of the mobile terminal device is executed, own-vessel's surrounding situational information depending on a time that elapses, the vessel collision preventing information, and the like are stored in the central server device or the mobile terminal device to be reused afterwards. That is, the information storing unit may serve as a black box when a vessel accident occurs.

(b) A central server device according to yet another exemplary embodiment of the present invention may provide marine information including a marine weather, tidal current, tide, and the like in addition to marine information on vessels or fixed obstacles to a mobile terminal device.

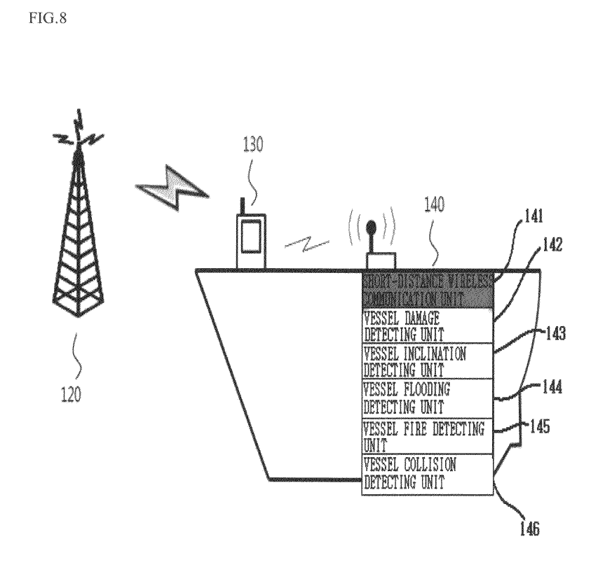

(c) FIG. 8 is a diagram for describing a system for safety of a vessel according to another exemplary embodiment of the present invention.

As shown in FIG. 8, the vessel safety system according to another exemplary embodiment of the present invention further includes a vessel state detecting device including a vessel damage detecting unit 141 detecting whether a user's vessel is damaged, a vessel inclination detecting unit 142 detecting capsizing of the user's vessel, a vessel flooding detecting unit 143 detecting whether the user's vessel is flooded, a vessel tire detecting unit 144 detecting whether the user's vessel is on tire, a vessel collision detecting unit 145 detecting whether the user's vessel is collided, and a short-distance wireless communication unit 146 converting detection values of the detecting units into vessel state signals and transmitting them to a mobile terminal device in the user's vessel. When each of the detection values of the vessel state signals received from the short-distance wireless communication unit 146 is equal to or more than a predetermined accident judging reference value, the mobile terminal device 130 may alarm vessel accident information and immediately transmit a vessel accident signal to the central server device 120.

In detail, the vessel inclination detecting unit 142 will be described. When a vessel exceeds a limit of a restoring force of the vessel, the vessel capsizes or is flooded. Most of vessel operators cannot accurately recognize the maximum restorable inclination angle of an own-vessel. They input the maximum restorable inclination angle of the own-vessel in their own mobile terminal devices 130, i.e., a ‘safety operation support program in the cellular phone at the time of building or checking a vessel. Information other than the maximum restorable inclination angle includes a current inclination angle of a vessel which is sailing.

The vessel safety system requires the vessel state detecting device 140 having sensors that can sense inclination angles, temperature, and humidity as shown in FIG. 8. This device is preferably installed in an engine room. An accident such as tire in the engine room due to damage of an engine may be immediately detected by installing this device in the engine room. A detected signal is transmitted to a vessel operator's cellular phone through a Bluetooth communication using the short-distance wireless communication unit 146. The Bluetooth wireless communication device has a general communication range of 10 m or more which satisfies a distance between the vessel operator having the cellular phone and the engine room in most small-sized vessels. The vessel state detecting device 140 continuously transmits the vessel inclination angle to the ‘safety operating support program’ which is being executed in the vessel operator's cellular phone and a predetermined set program judges a danger or not of the current own-vessel inclination angle by comparing the transmitted inclination angle with an own-vessel's maximum allowable inclination angle and thereafter, notifies the danger to the vessel operator when the danger is close to a dangerous value and transmits the danger even to the central server device 120 of a ground operation center. The central server device 120 that receives a signal indicating reaching of the dangerous inclination angle observes the corresponding vessel and contacts a maritime police and provides information to the marine police so as to take an immediate action for a vessel that transmits a signal value larger than the maximum restorable inclination angle and thereafter, is subjected to communication interruption.

Further, since a fire and an explosion in the engine room of the small-sized vessel may cause a serious marine accident including personal casualties, the central server device 120 notifies a fire occurrence signal detected through the temperature sensor of the vessel fire detecting unit 144 to the vessel operator to help the vessel operator take initial action when a fire occurs in the vessel. Further, the vessel collision detecting unit 145 may easily detect a collision or not of the vessel by distinguishing other vessels and obstacles from waves which collide with the vessel by means of an acceleration sensor, and the like.

As a result, in another exemplary embodiment of the present invention, when accidents such as a fire, collision, flooding, and the like occur in the vessel, it is possible to take initial action against the vessel accident by immediately transmitting an accident occurrence signal by using a wireless communication function of the mobile terminal device.

According to exemplary embodiments of the present invention, it is possible to provide a vessel collision preventing function which is available only in high-price exclusive marine equipment by utilizing a radio communication function and a location tracking function of a mobile terminal device even to small and medium-sized vessels and furthermore, it is possible to rapidly and accurately display a vessel which is in a collision risk and allow a user to specifically recognize a collision preventing alarm so as to prevent collisions of the vessels.

Further, when accidents such as a tire, collision, flooding, and the like occur, it is possible to take the initial action against the vessel accident by immediately transmitting an accident occurrence signal by using a wireless communication function of the mobile terminal device.

While certain embodiments have been described above, it will be understood to those skilled in the art that the exemplary embodiments described may be implemented by way of other detailed examples without modifying the spirit or essential features of the present invention.

The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. Accordingly, other implementations are within the scope of the following claims.

What is claimed is:

1. A system for safety of a vessel, comprising:
a marine information providing device generating and providing marine information on a plurality of vessels and fixed obstacles positioned at sea;
a central server device receiving and integrating the marine information and generating own-vessel's surrounding situational information depending on a location of a user's vessel; and
a mobile terminal device accessing the central server device to transmit the positional information of the user's vessel, receiving and displaying the own-vessel's surrounding situational information, generating vessel collision preventing information from the own-vessel's surrounding situational information to give an alarm, and displaying the own-vessel's surrounding situational information by compulsorily updating or reprocessing the own-vessel's surrounding situational information according to the input of a setup key.

2. The system of claim 1, wherein the mobile terminal device includes:
an information transmitting and receiving unit accessing the central server device to transmit the positional information of the user's vessel and receive the own-vessel's surrounding situational information;
a vessel collision preventing information generating unit generating the vessel collision preventing information on the basis of the own-vessel's surrounding situational information;
a setup changing unit compulsorily updating or reprocessing the own-vessel's surrounding situational information according to the input of the setup key; and
an information displaying unit displaying the own-vessel's surrounding situational information and alarming the vessel collision preventing information.

3. The system of claim 1, wherein the mobile terminal device displays the own-vessel's surrounding situational information by displaying the user's vessel as a triangle of which the position is fixed on the screen, displaying the distance from the user's vessel as concentric circles which are displayed at regular intervals on the basis of the user's vessel, displays other vessels as circles according to their positions, displaying the vessels as colors according to their sizes, displaying the vessels as direction lines drawn from circles according to their operating directions, and displaying the vessels as the number of the direction lines according to the operating speeds, and displaying the fixed obstacles as quadrangles.

4. The system of claim 1, wherein the mobile terminal device generates and alarms the vessel collision preventing information by calculating a DCPA and a TCPA of each of a plurality of vessels or fixed obstacles with the user's vessel on the basis of the own-vessel's surrounding situational information, when the DCPA and the TCPA are equal to or less than the collision preventing threshold value, displaying the DCPA and the TCPA, the speeds of the vessel and the user's vessel, and a vessel collision preventing alarm statement and generating vessel collision preventing alarm sound or alarm vibration, and displaying a collision preventing operating direction depending on the positions of the vessels or fixed obstacles.

5. The system of claim 4, wherein the mobile terminal device receives telephone number information of a mobile terminal device positioned in another vessel of which the DCPA and the TCPA are equal to or less than the collision preventing threshold value by accessing the central server device and displays a call connection to the telephone number.

6. The system of claim 1, wherein the information inputted by the setup key includes at least one of a compulsory updating command, a distance interval of concentric circles displayed on a screen, selection of an alarm type, an access cycle of a central server, change of the collision preventing threshold value, registration of the specification of the user's vessel, and the like.

7. The system of claim 1, wherein the central server device or the mobile terminal device includes an information storing unit storing the own-vessel's surrounding situational information or the vessel collision preventing information.

8. The system of claim 1, further comprising a vessel state detecting device including a vessel damage detecting unit detecting whether a user's vessel is damaged, a vessel inclination detecting unit detecting capsizing of the user's vessel, a vessel flooding detecting unit detecting whether the user's vessel is flooded, a vessel fire detecting unit detecting whether the users vessel is fired, a vessel collision detecting unit detecting whether the user's vessel is collided, and a short-distance wireless communication unit converting detection values of the detecting units into vessel state signals and transmitting them to a mobile terminal device in the user's vessel,
wherein when each of the detection values of the vessel state signals received from the short-distance wireless communication unit is equal to or more than a predetermined accident judging reference value, the mobile terminal device alarms vessel accident information and immediately transmit a vessel accident signal to the central server device.

9. A method for safety of a vessel, comprising:
transmitting of positional information of accessing a mobile terminal to a central server to transmit the positional information of the user's vessel;
displaying of own-vessel's surrounding situational information of receiving the own-vessel's surrounding situational information of the user's vessel from the central server and displaying the received information on a screen of the mobile terminal;
judging of a vessel collision risk of generating a DCPA and a TCPA from the own-vessel's surrounding situational information to judge the vessel collision risk or not;
alarming of vessel collision prevention of generating vessel collision preventing information based on the own-vessel's surrounding situational information to display the DCPA, the TCPA, speeds of the vessel and the user's vessel, and a vessel collision preventing alarm statement on the screen of the mobile terminal, generating vessel collision preventing alarm sound or alarm vibration in the mobile terminal, and displaying a collision preventing operating direction on the screen of the mobile terminal;
displaying of a call connection or not of receiving telephone number information of a mobile terminal positioned in a vessel which is under a collision risk by accessing the central server and displaying a call connection to the telephone number or not in the mobile terminal of the user's vessel; and
displaying of setup change information of displaying the own-vessel's surrounding situational information on the screen of the mobile terminal by compulsorily updating and reprocessing the corresponding information according to the input of the setup key of the mobile terminal.
